(19) United States
(12) Patent Application Publication
(10) Pub. No.: US 2020/0176785 A1
(43) Pub. Date: Jun. 4, 2020

(54) ELECTRODE MANUFACTURING METHOD TO SUPPRESS REARRANGEMENT OF IONOMERS DUE TO ELUTION OF PLATINUM OF POLYMER ELECTROLYTE MEMBRANE FUEL CELL

(71) Applicant: KOREA INSTITUTE OF ENERGY RESEARCH, Daejeon (KR)

(72) Inventors: Tae Young KIM, Jeonju-si (KR); Young Gi YOON, Daejeon (KR); Min Ho SEO, Yongin-si (KR); Chi Young JUNG, Seongnam-si (KR); Seung Yong YANG, Iksan-si (KR); Beom Jun KIM, Jeollabuk-do (KR); Jong Min LEE, Jeonju-si (KR); Myeong Lee KIM, Mungyeong-si (KR)

(73) Assignee: KOREA INSTITUTE OF ENERGY RESEARCH, Daejeon (KR)

(21) Appl. No.: 16/081,848

(22) PCT Filed: Dec. 8, 2017
(86) PCT No.: PCT/KR2017/014359

§ 371 Date: Aug. 31, 2018

(30) Foreign Application Priority Data
Jul. 19, 2017 (KR) 10-2017-0091573
Sep. 6, 2017 (KR) 10-2017-0113925

(51) Int. Cl. H01M 4/92; H01M 4/88

(52) U.S. Cl. CPC H01M 4/926; H01M 4/8892

(57) ABSTRACT

An ionomer structural support for an electrode of fuel cell, and a method thereof are provided. An electrode of fuel cell with an ionomer structural support includes a carbon support including a metal catalyst on a surface of the carbon support, at least one ionomer structural support selected from the group consisting of a carbon nanotube, a carbon nanofiber, and a carbon nanorod, the ionomer structural support being formed on the carbon support, and ionomers formed to cover the carbon support and the ionomer structural support.

### TECHNICAL FIELD

The present disclosure relates to an ionomer structural support for suppressing the degradation of an electrode of fuel cell and an electrode of fuel cell including the ionomer structural support and, more particularly, to an ionomer structural support that is used for an electrode of fuel cell and that includes a metal catalyst, a carbon support and an ionomer, a fuel cell including the ionomer structural support, and a method of manufacturing the electrode of fuel cell.

### BACKGROUND ART

A fuel cell is a device that generates electric energy by an electrochemical reaction between fuel and an oxidizing agent. Such a chemical reaction is performed by a catalyst within a catalyst layer, and generally electricity may continue to be generated as long as fuel is continuously supplied. Unlike an existing power generation scheme that results in a loss of an efficiency through multiple steps, an efficiency of the fuel cell is twice higher than that of an internal combustion engine because the fuel cell directly generates electricity, and concerns about resource depletion and environmental pollution issues may be reduced. The fuel cell is an electrochemical device that converts chemical energy of hydrogen and oxygen contained in a hydrocarbon-based material, such as methanol, ethanol, and natural gas, directly into electric energy, and corresponds to a power generation technology of continuing to produce electricity by supplying hydrogen and oxygen to an anode and a cathode, respectively.

Generally, the fuel cell has a basic structure including an anode, a cathode and a polymer electrolyte membrane. The anode includes a catalyst layer to promote an oxidation of fuel, and the cathode also includes a catalyst layer to promote a reduction of an oxidizing agent. Fuel is oxidized in the anode, to generate protons and electrons. The generated protons are transferred to the cathode through an electrolyte membrane, and the electrons are transferred to an external circuit through a conducting wire. In the cathode, the protons received through the electrolyte membrane, the electrons received from the external circuit through the conducting line, and oxygen bind to generate water. Movement of the electrons through the anode, the external circuit and the cathode corresponds to power. As described above, the anode and cathode of the fuel cell contain a catalyst to promote an electrochemical oxidation of fuel and a catalyst to promote an electrochemical reduction of oxygen, respectively.

Performance of a fuel cell greatly depends on catalytic performance of the anode and the cathode, and platinum (Pt) is most widely used as a catalyst material for the above electrodes. In particular, recently, a Pt/C catalyst in which platinum particles are supported on a carbon support (that is, a support) having a large specific surface area and an excellent electrical conductivity is being most commonly used as a catalyst material. Since Pt is very expensive as a precious metal, it is important to reduce an amount of platinum to be used when platinum particles are supported on the carbon support. Also, it is necessary to maximize the catalytic performance by effectively supporting a small amount of platinum through optimization of surrounding factors. Thus, recently, catalyst electrodes in which alloy particles that include platinum (Pt) and other metals, for example, a transition metal, such as nickel (Ni), palladium (Pd), rhodium (Rh), titanium (Ti), zirconium (Zr), cobalt (Co) and the like, are supported on a carbon-based material, are being developed.

Here, the above-described metal catalyst and/or the above-described carbon support are oxidized since the metal catalyst and the carbon support are not stable under electrochemical conditions of electrodes during an operation of the fuel cell, and performance thereof is degraded. Thus, it is necessary to solve such an issue of failing to ensure a long-term stability of a catalyst electrode in a commercialization of a fuel cell technology. Also, causes of a degradation in performance of the fuel cell and a dissolution of the metal catalyst and/or the carbon support have been analyzed from various perspectives, and various attempts to solve the above phenomenon have been made. However, effective methods have not been derived.

### DISCLOSURE OF INVENTION

### Technical Subject

The present disclosure is to solve a problem of a rapid decrease in a performance of a fuel cell due to a deterioration of a metal catalyst and/or a carbon support, as described above, and to clarify a cause of a great increase in a gas diffusion resistance when a metal catalyst and/or a carbon support (support) is deteriorated during an operation of the fuel cell. Also, example embodiments provide an electrode of fuel cell that introduces a metal catalyst and an ionomer structural support configured to prevent a rearrangement of ionomers on a carbon support, and provide a fuel cell including the electrode of fuel cell. Thus, the present disclosure is to reduce a degree of increase in a gas diffusion resistance and a degree of decrease in performance of the fuel cell which may be caused by the deterioration of the metal catalyst and/or the carbon support during the operation of the fuel cell.

### Technical Solution

According to an aspect, there is provided an electrode of fuel cell with an ionomer structural support, the electrode of fuel cell including a carbon support including a metal catalyst on a surface of the carbon support, at least one ionomer structural support selected from the group consisting of a carbon nanotube, a carbon nanofiber, and a carbon nanorod, the ionomer structural support being formed on the carbon support, and ionomers formed to cover the carbon support and the ionomer structural support.

The ionomer structural support may suppress a rearrangement of the ionomers due to a dissolution of the carbon support.

The metal catalyst and the ionomer structural support may perform an anchoring function to suppress a rearrangement or a flow of the ionomers during a deterioration process.

The rearrangement or the flow of the ionomers may be caused by a dissolution of either one or both of the metal catalyst and the carbon support.

The ionomer structural support may be present in an amount of 0.1 parts by weight to 5 parts by weight based on a weight of the carbon support.

The ionomer structural support may be included in an amount of 1.0% by weight (wt %) to 3.5 wt % based on a weight of the electrode of fuel cell. The ionomer structural support may be included in an amount of 1.4 wt % to 2.0 wt % based on a weight of the electrode of fuel cell.

The ionomer structural support may be irregularly located between particles of the carbon support.

The metal catalyst may include at least one selected from the group consisting of platinum, ruthenium, osmium, a platinum-palladium alloy, a platinum-ruthenium alloy, a platinum-cobalt alloy, a platinum-nickel alloy, a platinum-iridium alloy and a platinum-osmium alloy.

The carbon support may include at least one selected from the group consisting of Vulcan, carbon black, graphite carbon, acetylene black, ketjen black and carbon fiber.

The ionomers may include Nafion. According to another aspect, there is provided a fuel cell including a cathode, an anode, and an electrolyte formed between the cathode and the anode, wherein either one or both of the cathode and the anode include the electrode of fuel cell according to an example embodiment.

When the fuel cell is used during a period of time less than or equal to 14 hours in a voltage region between 0.3 V and 0.5 V, a reduction rate of a current density of the fuel cell may be less than or equal to 20%.

When the fuel cell is repeatedly used during 25,000 cycles in a voltage region between 0.6 V and 1.0 V, a reduction rate of a current density of the fuel cell may be less than or equal to 8%. When the fuel cell is repeatedly used during 50,000 cycles, a reduction rate of a current density of the fuel cell may be less than or equal to 20%.

When the fuel cell is repeatedly used during 25,000 cycles in a voltage region between 0.3 V and 0.6 V, a reduction rate of a current density of the fuel cell may be less than or equal to 4%. When the fuel cell is repeatedly used during 50,000 cycles, the reduction rate of the current density of the fuel cell may be less than or equal to 16%.

The fuel cell may be an air-breathing fuel cell or a passive fuel cell.

According to another aspect, there is provided a method of manufacturing an electrode of fuel cell, the method including preparing a carbon support including a metal catalyst on a surface of the carbon support, placing the carbon support on a substrate, dispersing an ionomer structural support on the substrate on which the carbon support is placed, and forming ionomers to cover the carbon support and the ionomer structural support, wherein the ionomer structural support includes at least one selected from the group consisting of a carbon nanotube, a carbon nanofiber, and a carbon nanorod.

The electrode of fuel cell may include the electrode of fuel cell according to an example embodiment.

### Effect

According to example embodiments, in an electrode of fuel cell including an ionomer structural support, and a fuel cell including the electrode of fuel cell, since the ionomer structural support is included in the electrode of fuel cell, an anchoring function may be allowed to be performed in response to a deterioration of a metal catalyst and/or a carbon support of the fuel cell, to prevent a creep of ionomers on the metal catalyst and the carbon support and to reduce a degree of rearrangement of the ionomers. Also, in the fuel cell, and the electrode of fuel cell including the ionomer structural support, an increase in a gas diffusion resistance may be suppressed even though the fuel cell continues to operate, and thus ultimately, an effect of decreasing a degree of decrease in performance of the fuel cell and of a degree of increase in the gas diffusion resistance may be expected.

### BRIEF DESCRIPTION OF DRAWINGS

FIG. 1 is a diagram illustrating a concept of a process in which ionomers are rearranged due to a dissolution of a carbon support from a catalyst electrode of a fuel cell that does not include an ionomer structural support, and in which an oxygen diffusion resistance of the catalyst electrode of the fuel cell increases, according to a related art.

FIG. 2 is a diagram illustrating a concept of a process in which an additional anchoring function is performed by a structure of a carbon nanotube support despite a dissolution of a carbon support from an electrode of fuel cell that includes an ionomer structural support according to an example embodiment so that a rearrangement of ionomers on the carbon support is suppressed and that an oxygen diffusion resistance of the electrode of fuel cell does not greatly change.

FIG. 3 is a diagram illustrating a concept of a process in which ionomers are rearranged due to a dissolution of a metal catalyst that performs an anchoring function from a catalyst electrode of a fuel cell that does not include an ionomer structural support, and in which an oxygen diffusion resistance of the catalyst electrode of the fuel cell increases, according to a related art.

FIG. 4 is a diagram illustrating a concept of a generation of an effect of suppressing a change in shapes of ionomers and of preventing agglomeration of the ionomers by a structure of a carbon nanotube support despite a dissolution of a metal catalyst from an electrode of fuel cell that includes an ionomer structural support according to an example embodiment.

FIG. 5 is a flowchart illustrating a process of each step of a method of manufacturing an electrode of fuel cell including a carbon nanotube support according to an example embodiment.

FIG. 6 is a graph illustrating a change in a current density versus a voltage based on a repetition cycle of a membrane electrode assembly (MEA) for a fuel cell manufactured as an example of the present disclosure.

FIG. 7 is a graph illustrating a change in a current density versus a voltage based on a repetition cycle of an MEA for a fuel cell manufactured as a comparative example of the present invention.

FIGS. 8 through 10 are graphs illustrating analysis results of a cell voltage value that changes during an operation of a fuel cell based on an amount (% by weight (wt %)) of a Nafion ionomer in a cathode layer that does not include a carbon nanotube support. FIG. 8 is a graph associated with a Nafion ionomer of 18 wt %, FIG. 9 is a graph associated with a Nafion ionomer of 27 wt %, and FIG. 10 is a graph associated with a Nafion ionomer of 36 wt %.

FIGS. 11 through 13 are graphs illustrating analysis results of a degree to which performance of an electrode is degraded during an operation of a fuel cell at each voltage based on an amount of a Nafion ionomer in a cathode layer that does not include a carbon nanotube support. FIG. 11 is a graph illustrating a degree to which performance for each of electrode of fuel cells that respectively include a Nafion ionomer of 18 wt %, a Nafion ionomer of 27 wt % and a Nafion ionomer of 36 wt %, is degraded at 0.8 V. FIG. 12 is a graph illustrating a degree to which performance for each of the electrode of fuel cells is degraded at 0.6 V, and FIG. 13 is a graph illustrating a degree to which performance for each of the electrode of fuel cells is degraded at 0.4 V.

FIGS. 14 through 17 are graphs illustrating a change in a current density versus a voltage based on an operating time in examples and a comparative example of the present disclosure. FIG. 14 is a graph of a cell degradation characteristic shown when a carbon nanotube is not included as the comparative example of the present disclosure, and FIGS. 15 through 17 are graphs illustrating cell degradation characteristics shown when a carbon nanotube support of 0.8 wt % (FIG. 15), a carbon nanotube support of 1.6 wt % (FIG. 16), and a carbon nanotube support of 3.2 wt % (FIG. 17) are included, as the examples of the present disclosure.

### BEST MODE FOR CARRYING OUT THE INVENTION

Hereinafter, example embodiments will be described in detail with reference to the accompanying drawings. Like reference numerals in the drawings refer to like elements throughout the present disclosure.

Various modifications may be made to example embodiments. However, it should be understood that these embodiments are not construed as limited to the illustrated forms and include all changes, equivalents or alternatives within the idea and the technical scope of this disclosure.

Terms used herein are to merely explain certain example embodiments, thus it is not meant to be limiting. A singular expression includes a plural expression except that two expressions are contextually different from each other. In the present invention, a term “include” or “have” is intended to indicate that characteristics, numbers, steps, operations, components, elements disclosed on the specification or combinations thereof exist. As such, the term “include” or “have” should be understood so as not to pre-exclude existence of one or more other characteristics, numbers, steps, operations, components, elements or combinations thereof or additional possibility.

Unless otherwise defined herein, all terms used herein including technical or scientific terms have the same meanings as those generally understood by one of ordinary skill in the art. Terms defined in dictionaries generally used should be construed to have meanings matching with contextual meanings in the related art and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in describing of example embodiments, detailed description of well-known related structures or functions will be omitted when it is deemed that such description will cause ambiguous interpretation of the present disclosure.

A fuel cell according to a related art has a problem that a performance rapidly decreases as a cycle progresses due to a dissolution caused by a deterioration of metal catalyst particles and/or a carbon support (support) under a specific operating condition such as startup, shutdown, insufficient hydrogen supply, and the like. A collapse of pores in a catalyst layer during a deterioration of a metal catalyst and/or a carbon support, a surface hydrophilization due to oxidation of a support and a flooding phenomenon in a catalyst layer, an elimination of a metal catalyst due to a dissolution of a support, and the like, have been known as major causes to increase a gas diffusion resistance of a fuel cell.

The present inventor has individually analyzed conventional theories that are considered as major causes of a reduction in a performance of a fuel cell and an increase in a gas diffusion resistance while the fuel cell is degraded. First, despite a theory indicating that a performance of a fuel cell decreases due to a phenomenon in which water is generated on a surface of a support to lead to a difficulty of an oxygen penetration, it was determined that generated water does not have a great influence because the generated water does not remain in a catalyst electrode without a change when considering a harsh operating environment of a fuel cell, as an experimental result of the present inventor. Second, despite a theory indicating that an amount of a metal catalyst decreases while a carbon support is eluted due to a degradation of a fuel cell, to reduce a performance of the fuel cell, it was analyzed that a decrease in the amount of the metal catalyst does not have a great influence on a reduction in the performance of the fuel cell, as an experimental result of the present inventor.

In other words, conventionally analyzed causes are not enough to clearly interpret the reason why a gas diffusion resistance that is most prominently shown during a deterioration of a metal catalyst and/or a carbon support, is greatly increased.

The present inventor has found that the gas diffusion resistance was mainly increased due to a rearrangement phenomenon and a creep phenomenon of ionomers that occurred while a material that performs an anchoring function for the ionomers disappears due to a dissolution of a metal catalyst and/or a carbon support of a fuel cell during a degradation of the metal catalyst and/or the carbon support, in addition to the analyzed causes. The present inventor has designed a configuration to prevent and suppress the above phenomena by analyzing the above phenomena through various experiments, to complete the present disclosure.

Example embodiments of the present disclosure provide an electrode of fuel cell including an ionomer structural support to suppress a rearrangement and a creep of ionomers that exist on a surface of a carbon support and a metal catalyst by paying attention to a rearrangement phenomenon of the ionomers as a major cause to increase a gas diffusion resistance value and to deteriorate the carbon support in a process of operating a fuel cell under high temperature and high humidity conditions.

According to an example embodiment, an electrode of fuel cell with an ionomer structural support includes a carbon support including a metal catalyst on a surface of the carbon support; at least one ionomer structural support that is selected from the group consisting of a carbon nanotube, a carbon nanofiber, and a carbon nanorod, and that is formed on the carbon support; and ionomers formed to cover the carbon support and the ionomer structural support.

In the present disclosure, the metal catalyst is supported on and included in the carbon support.

The carbon support may have a porous structure including the metal catalyst. In the present disclosure, the carbon support may form a structure in which a plurality of particles are collected.

In the present disclosure, a diameter of the carbon support refers to an average diameter of particles forming the carbon support. A diameter of the ionomer structural support refers to an average diameter of a plurality of ionomer structural supports, and a length of the ionomer structural support also refers to an average length of the plurality of ionomer structural supports. For example, an average diameter of carbon support particles and the average diameter and the average length of the ionomer structural supports may be determined as appropriate values, and thus it is possible to effectively suppress a rearrangement of ionomers despite a deterioration of the carbon support.

The metal catalyst may be configured to be exposed on a surface of the carbon support, and may perform an anchoring function to hold the ionomers so that the ionomers may be fixed on the carbon support. However, the metal catalyst may dissolve in the form of a cation due to frequent voltage fluctuations in the fuel cell during an operation of the fuel cell, or may move around another metal catalyst and attached to particles of the other metal catalyst to further increase metal catalyst particles in size. Thus, when a frictional force between the metal catalyst and the ionomers decreases, the anchoring function by the metal catalyst may disappear, and a rearrangement phenomenon or a creep phenomenon of the ionomers may greatly occur at a temperature condition of 70° C. or higher that is an operating condition of the fuel cell. Due to the rearrangement phenomenon of the ionomers, the ionomers may agglomerate, and an oxygen diffusion resistance in an electrode layer may rapidly increase, which has been a cause of a degradation in a performance of the fuel cell and a problem of a durability of the fuel cell during an operation of the fuel cell.

One of key features of the present disclosure is a feature of including the ionomer structural support to suppress a reduction in the performance. The ionomer structural support may be formed to be in contact with an external surface of the carbon support including the metal catalyst to support the external surface of the carbon support. The ionomer structural support may be formed of different types of materials to suppress a rearrangement and movement of the ionomers based on a carbon component.

The ionomer structural support may be used to suppress a rearrangement of the ionomers which is easily caused by a weakened frictional force between the metal catalyst and the ionomers after the metal catalyst is eluted. The ionomer structural support may be inserted between the ionomers to suppress agglomerating of the ionomers due to the rearrangement of the ionomers, so as to prevent an oxygen transfer resistance value on a platinum surface from being greatly increased. The ionomers may be located on the metal catalyst, the carbon support and the ionomer structural support to cover all the metal catalyst, the carbon support and the ionomer structural support.

According to an example embodiment, the ionomer structural support may be irregularly located between particles of the carbon support.

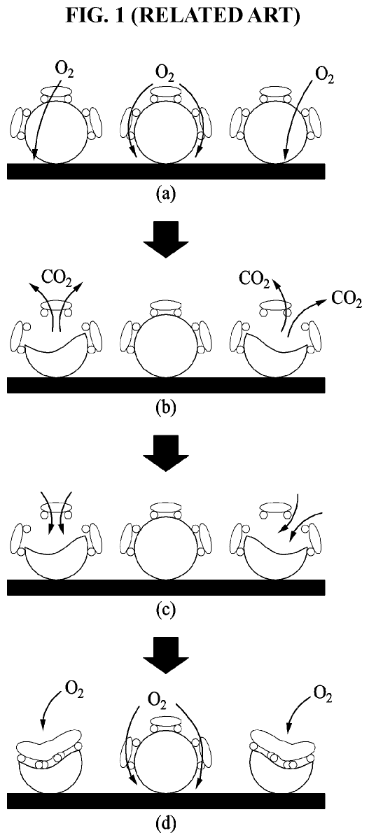

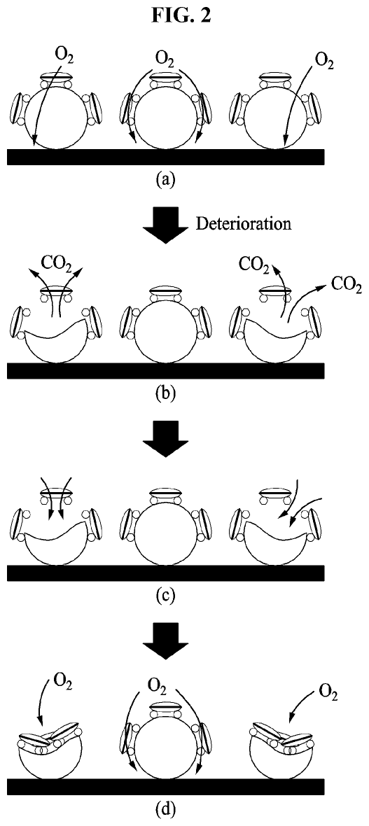

Hereinafter, a comparison of a structure of a catalyst electrode due to a dissolution of a carbon support between an electrode of fuel cell that does not include an ionomer structural support according to a related art and an electrode of fuel cell that includes an ionomer structural support according to an example embodiment will be described with reference to FIGS. 1 and 2.

FIG. 1 is a diagram illustrating a concept of a process in which ionomers are rearranged due to a dissolution of a carbon support from a catalyst electrode of a fuel cell that does not include an ionomer structural support, and in which an oxygen diffusion resistance of the catalyst electrode of the fuel cell increases, according to a related art.

Part (a) of FIG. 1 illustrates a process in which a catalyst electrode that includes a carbon support with metal catalysts and ionomers formed on the carbon support are exposed to oxygen gas during an operation of a fuel cell, and part (b) of FIG. 1 illustrates a process in which the carbon support is dented by eluting a portion of the carbon support by oxidizing the portion of the carbon support into carbon dioxide and discharging the carbon dioxide during the operation of the fuel cell, part (c) of FIG. 1 illustrates a process in which a creep phenomenon occurs in the ionomers around the carbon support and the ionomers are rearranged along the dented carbon support to increase a thickness of a portion of the ionomers, and part (d) of FIG. 1 illustrates a process in which an oxygen diffusion resistance value increases and a performance of the fuel cell decreases because it is difficult to diffuse oxygen based on an increase in the thickness of the ionomers.

FIG. 2 is a diagram illustrating a concept of a process in which an additional anchoring function is performed by a structure of a carbon nanotube support despite a dissolution of a carbon support from an electrode of fuel cell that includes an ionomer structural support according to an example embodiment so that a rearrangement of ionomers on the carbon support is suppressed and that an oxygen diffusion resistance of the electrode of fuel cell does not greatly change.

Part (a) of FIG. 2 illustrates a process in which a catalyst electrode that includes a carbon support with platinum metal catalysts, a carbon nanotube support that supports the carbon support, and ionomers formed on the carbon support is exposed to oxygen gas during an operation of a fuel cell, part (b) of FIG. 2 illustrates a process in which the carbon nanotube support supports the carbon support when a portion of the carbon support is eluted by oxidizing the portion of the carbon support into carbon dioxide and discharging the carbon dioxide during the operation of the fuel cell, part (c) of FIG. 2 illustrates a process in which a rearrangement of ionomers around the carbon support is suppressed by the carbon nanotube support despite a dissolution of the portion of the carbon support or the carbon support dented due to the dissolution and in which a uniform thickness of an ionomer is still maintained, and part (d) of FIG. 2 illustrates a process in which an effect of preventing an oxygen diffusion resistance from greatly increasing, by uniformly maintaining the thickness of the ionomer, so as to maintain a performance at a certain level even though the fuel cell continues to operate without a great reduction in the performance of the fuel cell.

Due to a dissolution of a carbon structure of the carbon support, a carrier structure may collapse in a portion of the carbon support, or another portion of the carbon support may be dented inwardly. Accordingly, polymer ionomers may be rearranged. The carbon nanotube support may be formed adjacent to the carbon support, to perform a function of suppressing a dent of the carbon support or a collapse of a structure of the carbon support or of preventing polymer ionomers from or being rearranged due to leaning or pouring of the polymer ionomers.

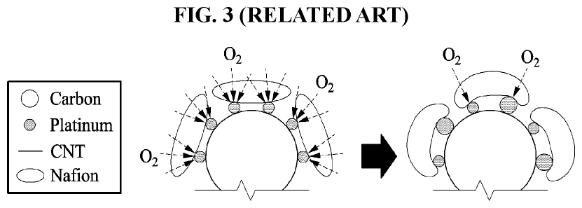

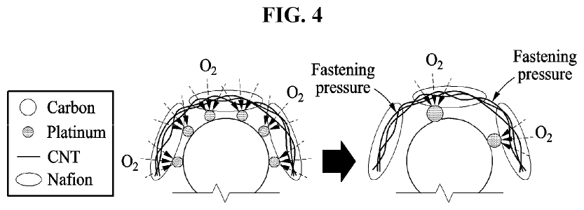

Hereinafter, a comparison of a structure of a catalyst electrode due to a dissolution of a metal catalyst between an electrode of fuel cell that does not include an ionomer structural support according to a related art and an electrode of fuel cell that includes an ionomer structural support according to an example embodiment will be described with reference to FIGS. 3 and 4.

FIG. 3 is a diagram illustrating a concept of a process in which ionomers are rearranged due to a dissolution of a metal catalyst that performs an anchoring function from a catalyst electrode of a fuel cell that does not include an ionomer structural support, and in which an oxygen diffusion resistance of the catalyst electrode of the fuel cell increases, according to a related art.

FIG. 3 shows a process in which a metal catalyst is dissolved and eluted at a specific location during an operation of the fuel cell, moves to another location and is attached, in the catalyst electrode that includes a carbon support with metal catalysts, and ionomers formed on(*above the carbon support. As shown in FIG. 3, the metal catalyst at the specific location may be reduced in size or may be lost during the operation of the fuel cell so that the metal catalyst may not perform an anchoring function for ionomers. Available space between a support and ionomers may be created due to an eluted catalyst, or ionomers may be rearranged due to a reduction in a frictional force between a catalyst and ionomers, which may cause a problem of increasing an oxygen diffusion resistance of the fuel cell.

FIG. 4 is a diagram illustrating a concept of a process in which a function like a frame of preventing agglomeration of ionomers by a structure of an ionomer structural support despite a dissolution of a metal catalyst from an electrode of fuel cell that includes the ionomer structural support according to an example embodiment, so that a rearrangement of ionomers on a carbon support is suppressed or that an oxygen diffusion resistance of the electrode of fuel cell does not greatly change even though a portion of ionomers are rearranged.

It may be found based on FIG. 4 that when ionomer structural supports such as carbon nanotubes are included in a metal catalyst and a carbon support, ionomers may be formed between carbon nanotubes, and the carbon nanotubes may perform a function like a frame to suppress a rearrangement of ionomers and to maintain the oxygen diffusion resistance.

In the present disclosure, the metal catalyst may be an important component associated with the rearrangement of the ionomers. The metal catalyst may perform an anchoring function for the ionomers, and may perform a function similar to the carbon support because the ionomers may be rearranged when the metal catalyst is eluted.

According to an example embodiment, the metal catalyst and the ionomer structural support may perform a function of suppressing a flow or a rearrangement of the ionomers during a deterioration process.

According to an example embodiment, the ionomers may flow or be rearranged due to a dissolution of either one or both of the metal catalyst and the carbon support.

The dissolution refers to a reduction in an amount of either one or both of the metal catalyst and the carbon support at a specific location. The dissolution includes a concept of a movement of either one or both of the metal catalyst and the carbon support from one location to another location. This is because an amount of at least one of the metal catalyst and the carbon support at the one location may be reduced.

The metal catalyst may be eluted due to a phenomenon of dissolution in a cationic form caused by frequent voltage fluctuations in the fuel cell. The carbon support may be eluted when a portion of the carbon support is oxidized into carbon dioxide and the carbon dioxide is discharged during an operation of the fuel cell. Due to the above dissolution of either one or both of the metal catalyst and the carbon support, at least one of the metal catalyst and the carbon support may be dented or reduced in size, or at least one of a metal catalyst and a carbon support at another location may be increased in size.

According to an example embodiment, the ionomer structural support may be present in an amount of 0.1 parts by weight to 5 parts by weight based on the carbon support. When the amount of the ionomer structural support is less than 0.1 parts by weight, effective suppression of a rearrangement and a creep phenomenon of polymer ionomers according to the present disclosure may be impossible due to a small number of ionomer structural supports that suppress a dent or a collapse of the carbon support. When the amount of the ionomer structural support exceeds 5 parts by weight, a problem may occur in a manufacturing process because an extremely large amount of the ionomer structural support is included in comparison to a weight of the carbon support. More desirably, the ionomer structural support may be present in an amount of 0.1 parts by weight to 3 parts by weight based on the carbon support.

The carbon support may form a structure in which a plurality of particles agglomerate. In the present disclosure, a diameter of the carbon support refers to an average diameter of particles forming the carbon support. A diameter of the carbon nanotube support refers to an average diameter of a plurality of carbon nanotube supports, and a length of the carbon nanotube support also refers to an average length of a plurality of carbon nanotube supports. For example, the average diameter of the particles of the carbon support, and the average diameter and the average length of the carbon nanotubes may be determined as appropriate values, and thus it is possible to effectively suppress a rearrangement of polymer ionomers despite a deterioration of the carbon support.

According to an example embodiment, the ionomer structural support may be included in an amount of 1.0% by weight (wt %) to 3.5 wt % based on a weight of the electrode of fuel cell.

When the amount of the ionomer structural support is less than 1.0 wt % based on the weight of the electrode of fuel cell, effective suppression of a rearrangement and a creep phenomenon of ionomers according to the present disclosure may be impossible due to a small number of ionomer structural supports that suppress a dent or a collapse of the carbon support. When the amount of the ionomer structural support exceeds 3.5 wt %, a problem may occur in a manufacturing process because an extremely large amount of the ionomer structural support is included in comparison to the weight of the carbon support. Desirably, the carbon nanotube support may be included in an amount of 1.6 wt % to 3.2 wt % based on the weight of the carbon support.

According to an example embodiment, the ionomer structural support may be included in an amount of 1.4 wt % to 2.0 wt % based on the weight of the electrode of fuel cell.

According to an example embodiment, the ionomer structural support may be irregularly located between particles of the carbon support.

Ionomer structural supports may be irregularly dispersed and placed in contact with particles of the carbon support and particles of the metal catalyst, as shown in FIGS. 2 and 4. Also, the ionomer structural supports may be located between the particles of the carbon support and the particles of the metal catalyst. According to one aspect, a location of the ionomer structural support may be variously changed based on any arrangement or placement of the ionomer structural supports to suppress a rearrangement of ionomers despite a dissolution of either one or both of the carbon support and the metal catalyst, and the ionomer structural supports may be designed to be regularly arranged in comparison to a location of the carbon support.

According to an example embodiment, the metal catalyst may include at least one selected from the group consisting of platinum, ruthenium, osmium, a platinum-palladium alloy, a platinum-ruthenium alloy, a platinum-cobalt alloy, a platinum-nickel alloy, a platinum-iridium alloy and a platinum-osmium alloy.

According to one aspect, the metal catalyst may include, but is not particularly limited to, any metal capable of being generally included in a catalyst electrode of a fuel cell and used, in addition to the above metal materials, and platinum may desirably be used as a metal catalyst.

According to an example embodiment, the carbon support may include at least one selected from the group consisting of Vulcan, carbon black, graphite carbon, acetylene black, ketjen black and carbon fiber.

According to an example embodiment, the ionomers may include Nafion.

According to another aspect, a fuel cell manufactured by including the above-described electrode of fuel cell may be provided.

In the present disclosure, the fuel cell may include a cathode; an anode; and an electrolyte formed between the cathode and the anode, and either one or both of the cathode and the anode may include an electrode of fuel cell according to an example embodiment.

According to an example embodiment, when the fuel cell is used during a period of time less than or equal to 14 hours in a voltage region between 0.3 V and 0.5 V, a reduction rate of a current density of the fuel cell may be less than or equal to 20%.

According to an example embodiment, when the fuel cell is repeatedly used during 25,000 cycles in a voltage region between 0.6 V and 1.0 V, the reduction rate of the current density of the fuel cell may be less than or equal to 8%. When the fuel cell is repeatedly used during 50,000 cycles, the reduction rate of the current density of the fuel cell may be less than or equal to 20%.

According to an example embodiment, when the fuel cell is repeatedly used during 25,000 cycles in a voltage region between 0.3 V and 0.6 V, the reduction rate of the current density of the fuel cell may be less than or equal to 4%. When the fuel cell is repeatedly used during 50,000 cycles, the reduction rate of the current density of the fuel cell may be less than or equal to 16%.

According to an example embodiment, the fuel cell may be an air-breathing fuel cell or a passive fuel cell.

The electrode of fuel cell provided in the present disclosure and the fuel cell manufactured using the electrode of fuel cell may be applied to an air-breathing fuel cell, to realize an excellent effect. However, the electrode of fuel cell and the fuel cell may sufficiently efficiently operate even though the electrode of fuel cell and the fuel cell are applied to a passive fuel cell. In the present disclosure, the passive fuel cell is used as a concept that refers to fuel cells other than an air-breathing fuel cell.

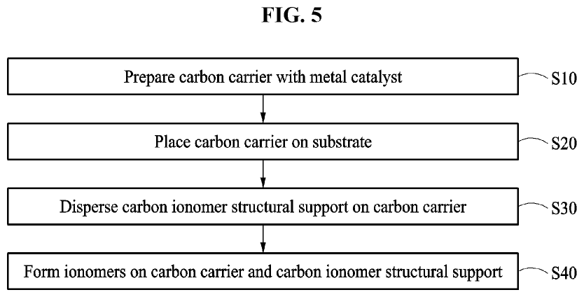

FIG. 5 is a flowchart illustrating a process of each step of a method of manufacturing an electrode of fuel cell including a carbon nanotube support according to an example embodiment.

The method of manufacturing an electrode of fuel cell includes step S10 of preparing a carbon support including a metal catalyst on a surface of the carbon support; step S20 of placing the carbon support on a substrate; step S30 of dispersing an ionomer structural support on the substrate on which the carbon support is placed; and step S40 of forming ionomers to cover the carbon support and the ionomer structural support, and the ionomer structural support may include at least one selected from the group consisting of a carbon nanotube, a carbon nanofiber and a carbon nanorod.

Using the method, it is possible to effectively disperse the ionomer structural support so that the ionomer structural support may have a structure to suppress a rearrangement of ionomers despite a dissolution of either one or both of the carbon support and the metal catalyst and to support the ionomers.

According to an example embodiment, the electrode of fuel cell may be an electrode of fuel cell according to an example embodiment.

### EXAMPLE 1

As an example of the present disclosure, a platinum catalyst was supported on a porous carbon support formed of Vulcan, to form a carbon support including the platinum catalyst. Next, a carbon nanotube as an ionomer structural support corresponding to 1.6 wt % in a total weight of the carbon support was dispersed around the carbon support, and a Nafion ionomer layer was formed to cover the carbon support and the carbon nanotube. Accordingly, an electrode of fuel cell including the ionomer structural support was formed, a membrane electrode assembly (MEA) for a fuel cell was formed together with an anode, a cathode and an electrolyte, and a repetitive operation was performed up to 50,000 cycles while changing a voltage applied to a cell from 0.2 V to 1.0 V, to confirm a performance reduction rate during an operation of a fuel cell.

As a comparative example for comparison with the example in terms of a degree of performance degradation during the operation of the fuel cell, a comparative example sample was formed by forming an MEA for a fuel cell in the same manner as in the example except that an ionomer structural support was not formed, and the same experiment as that of the example was conducted to confirm the degree of the performance degradation during the operation of the fuel cell.

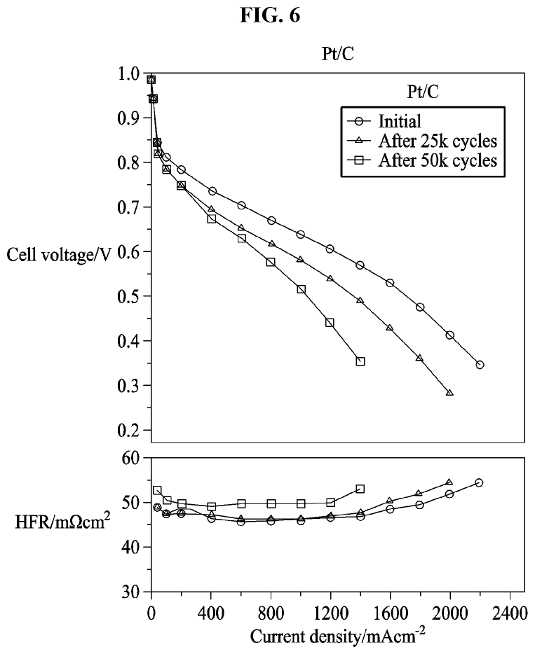

FIG. 6 is a graph illustrating a change in a current density versus a voltage based on a repetition cycle of an MEA for a fuel cell manufactured as an example of the present disclosure.

Table 1 shows a reduction rate reduced based on a potential repetition cycle of 0.6 V to 1.0 V of the MEA manufactured as the example of the present disclosure for each voltage (0.6 V and 0.4 V).

TABLE 1

| | |
|---|---|
| Applied voltage 0.6 V | Applied voltage 0.4 V |

| | Current | Reduction | Current | Reduction |
|---|---|---|---|---|
| Repetition | density | rate | density | rate |
| cycle | (mA/cm²) | (%) | (mA/cm²) | (%) |
| Initial | 1117 | 0 | 2078 | 0 |
| 25k | 1052 | 5.8 | 2035 | 2.1 |
| 50k | 911 | 18.4 | 1771 | 14.8 |

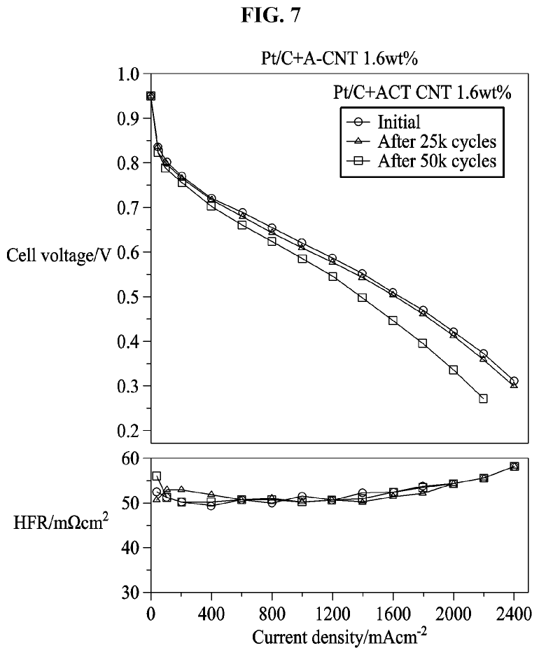

FIG. 7 is a graph illustrating a change in a current density versus a voltage based on a repetition cycle of an MEA for a fuel cell manufactured as a comparative example of the present invention.

Table 2 shows a reduction rate reduced based on a potential repetition cycle of the MEA manufactured as the comparative example of the present disclosure for each voltage (0.6 V and 0.4 V).

TABLE 2

| | |
|---|---|
| Applied voltage 0.6 V | Applied voltage 0.4 V |

| | Current | Reduction | Current | Reduction |
|---|---|---|---|---|
| Repetition | density | rate | density | rate |
| cycle | (mA/cm²) | (%) | (mA/cm²) | (%) |
| Initial | 1215 | 0 | 2034 | 0 |
| 25k | 879 | 26 | 1674 | 18 |
| 50k | 703 | 42 | 1285 | 37 |

It was confirmed that in the example in which the electrode of fuel cell including the ionomer structural support was formed, a difference between the reduction rates of the current density in response to an increase in an operating time was reduced, in comparison to the comparative example in which the ionomer structural support was not formed.

Through the experiments, it was confirmed that in the example in which the ionomer structural support was included, a degree of increase in an oxygen diffusion resistance was reduced and a performance degradation was alleviated even though either one or both of the carbon support and the metal catalyst were eluted when an operating time of the fuel cell increased, in comparison to the comparative example.

### EXAMPLE 2

As another example of the present disclosure, a platinum catalyst was supported on a carbon support formed of Vulcan, to form a carbon support including the platinum catalyst. Next, a carbon nanotube support corresponding to 0.8 wt % in a total weight of the carbon support was dispersed around the carbon support, and a Nafion ionomer layer in various amounts was formed to cover the carbon support and the carbon nanotube support. Accordingly, an electrode of fuel cell (cathode) including the carbon nanotube support was formed, an MEA for a fuel cell was formed together with an anode and an electrolyte, to verify results through the following experiments and to evaluate a degree of performance degradation during an operation of the fuel cell.

As a comparative example for comparison with the above example in terms of a degree of performance degradation during the operation of the fuel cell, a comparative example sample was formed by forming an MEA for a fuel cell in the same manner as in the example except that a carbon nanotube support was not formed, and the same experiment as that of the example was conducted to verify the results.

For comparative examples in which polymer ionomers were present in various amounts and in which a carbon nanotube support was not included, a degree of a degradation of a cell during an operation of a fuel cell was measured.

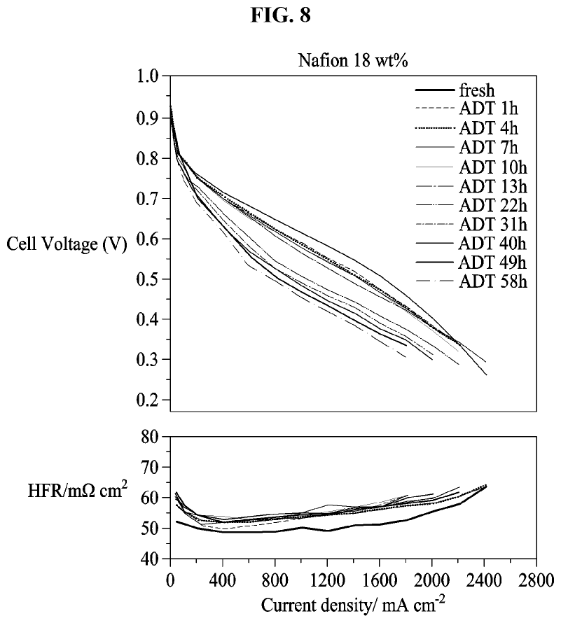

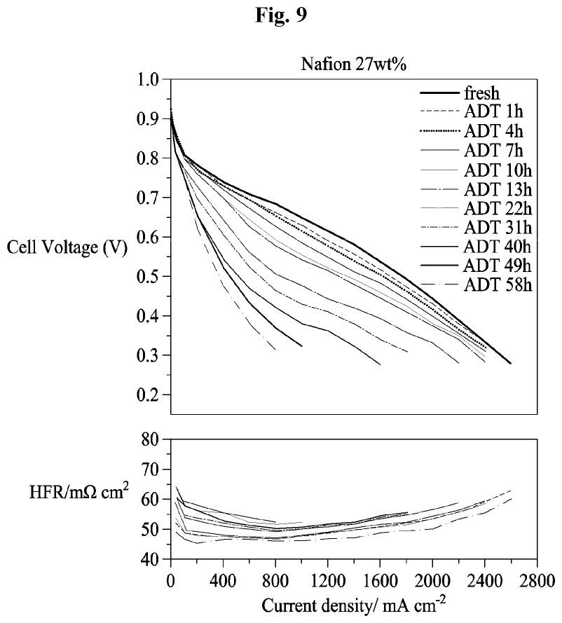

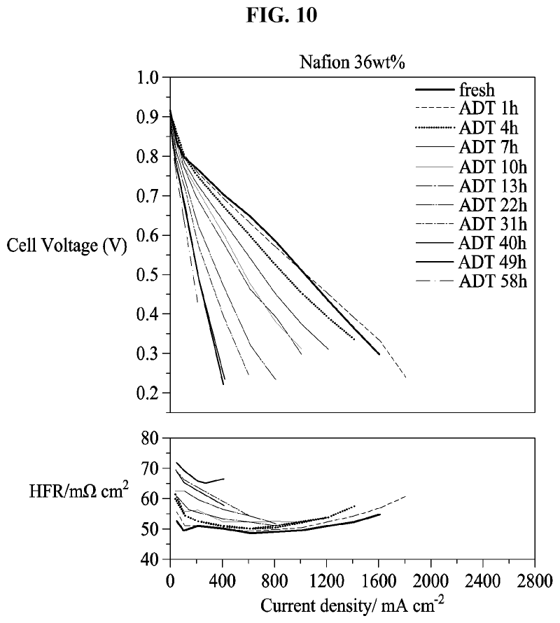

FIGS. 8 through 10 are graphs illustrating analysis results of a cell voltage value that changes during an operation of a fuel cell based on an amount (wt %) of a Nafion ionomer in a cathode layer that does not include a carbon nanotube support. FIG. 8 is a graph associated with a Nafion ionomer of 18 wt %, FIG. 9 is a graph associated with a Nafion ionomer of 27 wt %, and FIG. 10 is a graph associated with a Nafion ionomer of 36 wt %.

In the present experiment, the fuel cells were connected at a high potential of 1.3 V, and an initial current density and current densities for each operating time slot up to 58 hours were measured.

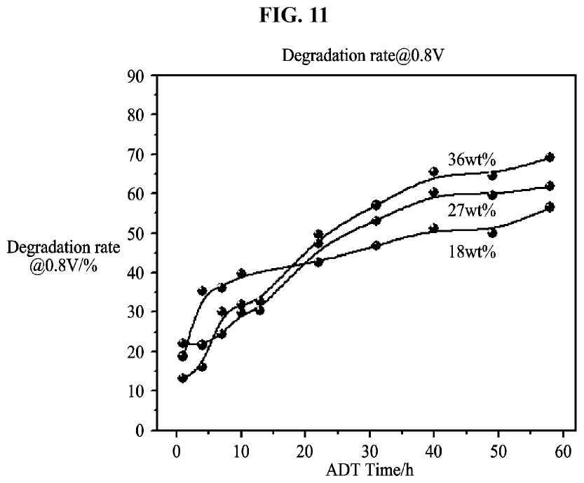

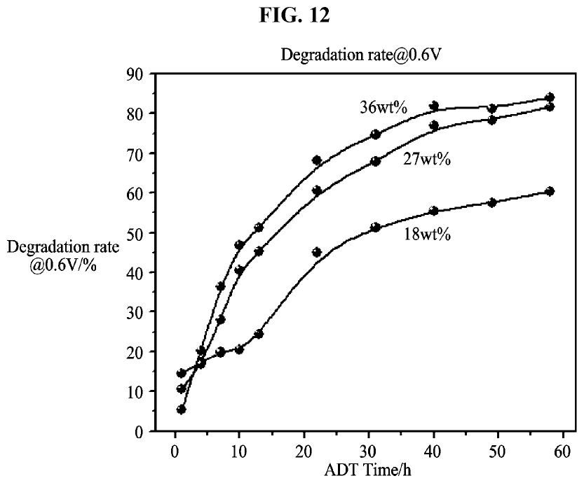

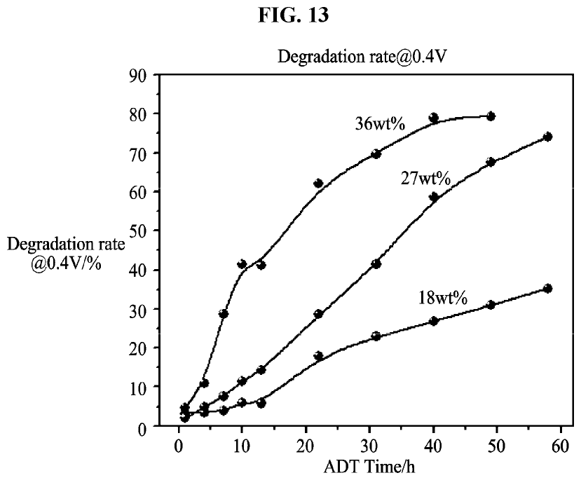

FIGS. 11 through 13 are graphs illustrating analysis results of a degree to which an electrode performance is degraded during an operation of a fuel cell at each voltage based on an amount of a Nafion ionomer in a cathode layer that does not include a carbon nanotube support. FIG. 11 is a graph illustrating a degree to which performance for each of electrode of fuel cells that respectively include a Nafion ionomer of 18 wt %, a Nafion ionomer of 27 wt % and a Nafion ionomer of 36 wt %, is degraded at 0.8 V. FIG. 12 is a graph illustrating a degree to which performance for each of the electrode of fuel cells is degraded at 0.6 V, and FIG. 13 is a graph illustrating a degree to which performance for each of the electrode of fuel cells is degraded at 0.4 V.

As shown in the above graphs, it was confirmed that the performance was greatly degraded since a reduction rate of performance of an electrode in the full cell increased as an amount of the Nafion ionomer increased. In particular, as the amount of the ionomer increased, a degradation rate in a low potential region in which a gas diffusion resistance is dominant was further increased.

For fuel cells including the electrode of fuel cells manufactured in the example and the comparative example, a current density was measured while changing a voltage for each time zone (for example, initial, after 10 hours, and after 14 hours) after operations of the full cells started.

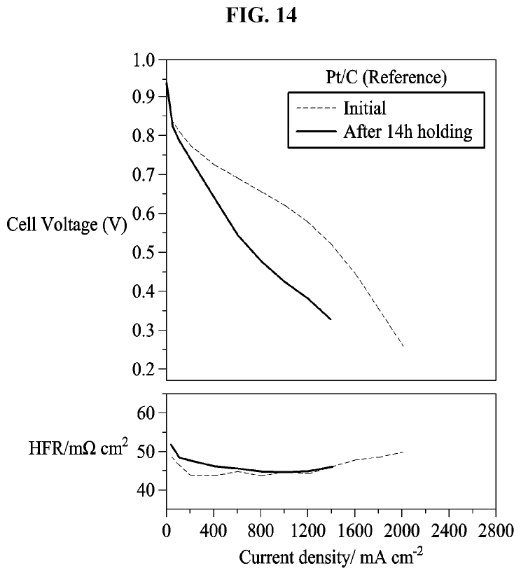

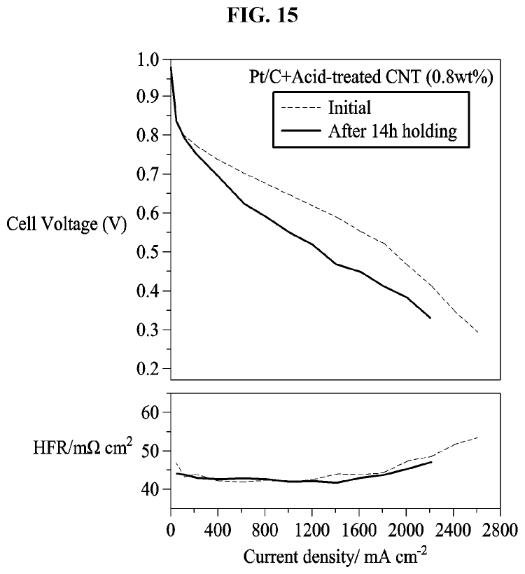

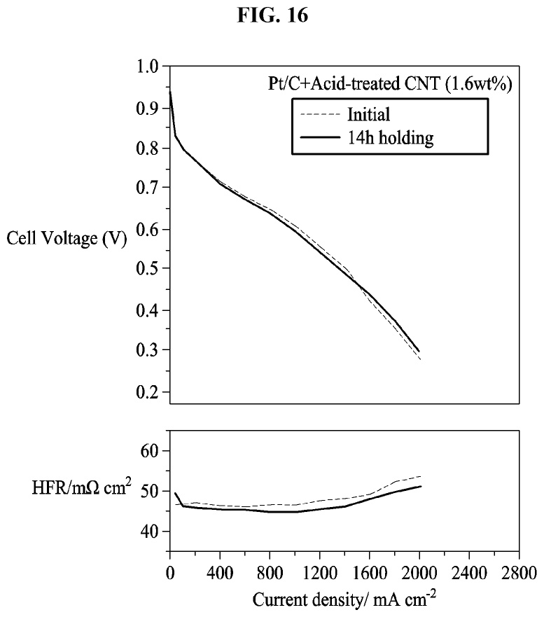

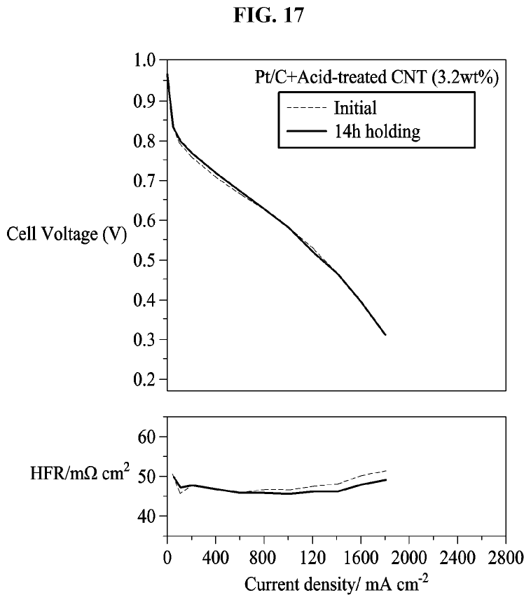

FIGS. 14 through 17 are graphs illustrating a change in a current density versus a voltage based on an operating time in examples and a comparative example of the present disclosure. FIG. 14 is a graph of a cell degradation characteristic shown when a carbon nanotube is not included, as the comparative example of the present disclosure, and FIGS. 15 through 17 are graphs of cell degradation characteristics shown when a carbon nanotube support of 0.8 wt % (FIG. 15), a carbon nanotube support of 1.6 wt % (FIG. 16), and a carbon nanotube support of 3.2 wt % (FIG. 17) are included, as the examples of the present disclosure.

In the present experiment, the full cells with the conditions were connected at a high potential of 1.3 V, an initial current density was measured, a current density was measured after a fuel cell operated for 14 hours, and the initial current density and the current density were compared. It was confirmed that in the example, performance of the fuel cell was not greatly degraded even though the fuel cell operated over 14 hours, whereas in the comparative example, the current density was greatly reduced. In particular, it was confirmed that, in an example in which a carbon nanotube support is included in an amount greater than or equal to 1.6 wt % among the examples, an initial performance and a performance reduction rate within 5% were shown even though the operating time has passed 14 hours, and a degradation characteristic was hardly observed.

Thus, it was confirmed that a difference between reduction rates of the current density based on an increase in the operating time was reduced in the examples in which the electrode of fuel cells including the carbon nanotube supports were formed, in comparison to the comparative example in which the carbon nanotube support was not formed.

While this disclosure includes specific example embodiments, it will be apparent to one of ordinary skill in the art that various changes in form and details may be made in these example embodiments without departing from the spirit and scope of the claims and their equivalents. The example embodiments described herein are to be considered in a descriptive sense only, and not for purposes of limitation. Descriptions of features or aspects in each example embodiment are to be considered as being applicable to similar features or aspects in other example embodiments. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. An electrode of fuel cell with an ionomer structural support, the electrode of fuel cell comprising:
a carbon support comprising a metal catalyst on a surface of the carbon support;
at least one ionomer structural support selected from the group consisting of a carbon nanotube, a carbon nanofiber, and a carbon nanorod, the ionomer structural support being formed on the carbon support; and ionomers formed to cover the carbon support and the ionomer structural support.

2. The electrode of fuel cell of claim 1, wherein the ionomer structural support suppresses a rearrangement of the ionomers due to a dissolution of the carbon support.

3. The electrode of fuel cell of claim 1, wherein the metal catalyst and the ionomer structural support perform an anchoring function to suppress a rearrangement or a flow of the ionomers during a deterioration process.

4. The electrode of fuel cell of claim 3, wherein the rearrangement or the flow of the ionomers is caused by a dissolution of either one or both of the metal catalyst and the carbon support.

5. The electrode of fuel cell of claim 1, wherein the ionomer structural support is present in an amount of 0.1 parts by weight to 5 parts by weight based on a weight of the carbon support.

6. The electrode of fuel cell of claim 1, wherein the ionomer structural support is included in an amount of 1.0% by weight (wt %) to 3.5 wt % based on a weight of the electrode of fuel cell.

7. The electrode of fuel cell of claim 1, wherein the ionomer structural support is included in an amount of 1.4 wt % to 2.0 wt % based on a weight of the electrode of fuel cell.

8. The electrode of fuel cell of claim 1, wherein the ionomer structural support is irregularly located between particles of the carbon support.

9. The electrode of fuel cell of claim 1, wherein the metal catalyst comprises at least one selected from the group consisting of platinum, ruthenium, osmium, a platinum-palladium alloy, a platinum-ruthenium alloy, a platinum-cobalt alloy, a platinum-nickel alloy, a platinum-iridium alloy and a platinum-osmium alloy.

10. The electrode of fuel cell of claim 1, wherein the carbon support comprises at least one selected from the group consisting of Vulcan, carbon black, graphite carbon, acetylene black, ketjen black and carbon fiber.

11. The electrode of fuel cell of claim 1, wherein the ionomers comprise Nafion.

12. A fuel cell comprising:
a cathode;
an anode; and
an electrolyte formed between the cathode and the anode,
wherein either one or both of the cathode and the anode comprise the electrode of fuel cell of claim 1.

13. The fuel cell of claim 11, wherein a reduction rate of a current density of the fuel cell is less than or equal to 20% when the fuel cell is used during a period of time less than or equal to 14 hours in a voltage region between 0.3 V and 0.5 V.

14. The fuel cell of claim 11, wherein
a reduction rate of a current density of the fuel cell is less than or equal to 4% when the fuel cell is repeatedly used during 25,000 cycles in a voltage region between 0.3 V and 0.6 V, and
the reduction rate of the current density of the fuel cell is less than or equal to 16% when the fuel cell is repeatedly used during 50,000 cycles.

15. The fuel cell of claim 12, wherein the fuel cell is an air-breathing fuel cell or a passive fuel cell.

16. A method of manufacturing an electrode of fuel cell, the method comprising:
preparing a carbon support comprising a metal catalyst on a surface of the carbon support;
placing the carbon support on a substrate;
dispersing an ionomer structural support on the substrate on which the carbon support is placed; and
forming ionomers to cover the carbon support and the ionomer structural support,
wherein the ionomer structural support comprises at least one selected from the group consisting of a carbon nanotube, a carbon nanofiber, and a carbon nanorod.

17. The method of claim 16, wherein the electrode of fuel cell comprises:
the carbon support comprising the metal catalyst on the surface of the carbon support;
the ionomer structural support which is formed on the carbon support; and
the ionomers formed to cover the carbon support and the ionomer structural support.
